(19) United States
(12) Patent Application Publication
(10) Pub. No.: US 2011/0052465 A1
(43) Pub. Date: Mar. 3, 2011

(54) PROCESS FOR PREPARING AN ACTIVATED MINERAL

(76) Inventor: Harold Boerrigter, Amsterdam (NL)

(21) Appl. No.: 12/864,366

(22) PCT Filed: Jan. 21, 2009
(86) PCT No.: PCT/EP2009/050623

§ 371 Date: Oct. 7, 2010

(30) Foreign Application Priority Data
Jan. 25, 2008 (EP) 08100915.1

(51) Int. Cl. C01B 33/24; C01B 33/12; B01D 53/62

(52) U.S. Cl. 423/230; 423/331; 423/335

(57) ABSTRACT

The invention provides a process for the activation of a magnesium or calcium sheet silicate hydroxide mineral comprising: (a) providing a bed of magnesium or calcium sheet silicate hydroxide mineral particles; (b) supplying to such bed a fluid fuel and molecular oxygen-comprising gas; and (c) allowing the fuel and molecular oxygen to react to obtain activated magnesium or calcium sheet silicate hydroxide mineral particles and a flue gas. In another aspect the invention provides an activated magnesium or calcium sheet silicate hydroxide mineral and a process for sequestration of carbon dioxide by mineral carbonation.

### FIELD OF THE INVENTION

The present invention provides a process for the activation of a magnesium or calcium sheet silicate hydroxide mineral, an activated magnesium or calcium sheet silicate hydroxide mineral and a process for sequestration of carbon dioxide by mineral carbonation.

### BACKGROUND OF THE INVENTION

It is known that carbon dioxide may be sequestered by mineral carbonation. In nature, stable carbonate minerals and silica are formed by a reaction of carbon dioxide with natural silicate minerals:

(Mg,Ca)ₓSi_{y}O_{x+2y}+xCO₂ [symbol] x(Mg,Ca)CO₃+ySiO₂

It is known that orthosilicates or chain silicates can be relatively easy reacted with carbon dioxide to form carbonates and can thus suitably be used for carbon dioxide sequestration. Examples of magnesium or calcium orthosilicates suitable for mineral carbonation are olivine, in particular forsterite, and monticellite. Examples of suitable chain silicates are minerals of the pyroxene group, in particular enstatite or wollastonite.

In WO02/085788, for example, is disclosed a process for mineral carbonation of carbon dioxide wherein particles of silicates selected from the group of ortho-, di-, ring, and chain silicates, are dispersed in an aqueous electrolyte solution and reacted with carbon dioxide.

The more abundantly available magnesium or calcium silicate hydroxide minerals, for example serpentine and talc, are sheet silicates and are more difficult to convert into carbonates, i.e. the reaction times for carbonation are much longer. Such sheet silicate hydroxides need to undergo a heat treatment or activation at elevated temperatures prior to the reaction with carbon dioxide.

In WO2007060149, a process is described for activating serpentine by conversion to olivine, wherein the serpentine is contacted with a hot synthesis gas. The activation of serpentine and talc takes place at temperatures between 600 and 800° C. According to the disclosure of WO2007060149, below 600° C., there is no significant conversion of serpentine into olivine and above 800° C., a crystalline form of olivine is formed that is more difficult to react with carbon dioxide than the amorphous olivine formed at a temperature below 800° C. In order to provide sufficient energy to activate the serpentine, syngas is used with temperatures up to 1600°. Such high temperatures impose constraints on the design of the reactor and require the use of materials suitable to withstand such high temperatures. Furthermore, the use to syngas having a temperature above 800° C. may lead to part of the serpentine to be converted into the crystalline form of olivine. Furthermore, it limits the application of the process to systems in which hot syngas is present.

### SUMMARY OF THE INVENTION

It has now been found that the energy for activating sheet silicate hydroxide minerals such as serpentine or talc can be advantageously provided by the in-situ combustion of a fuel. The thus-formed activated sheet silicate hydroxide minerals can be carbonated in a mineral carbonation step.

Accordingly, the present invention provides a process for the activation of a magnesium or calcium sheet silicate hydroxide mineral comprising:

(a) providing a bed of magnesium or calcium sheet silicate hydroxide mineral particles;
(b) supplying to such bed a fluid fuel and molecular oxygen-comprising gas; and
(c) allowing the fuel and molecular oxygen to react to obtain activated magnesium or calcium sheet silicate hydroxide mineral particles and a flue gas.

An advantage of the process of the invention is that a magnesium or calcium sheet silicate hydroxide mineral can be activated without the need to provide externally supplied hot gasses. The temperature and energy required to activate the magnesium or calcium sheet silicate hydroxide mineral is generated in-situ.

Another advantage is that there are less temperature constraints on the design of the reactor. There is no need to use materials capable of withstanding temperatures significantly exceeding 1000° C. or, in case the mineral is serpentine, even 800°.

A further advantage is that there is no need to supply hot syngas or even any other hot gas. Any suitable fluid fuel combined with e.g. air can be used. Such fluid fuels are typically available at locations where carbon dioxide is produced, especially at power generation facilities.

In a further aspect, the invention provides an activated magnesium or calcium sheet silicate hydroxide mineral. This mineral is especially suitable for mineral carbonation purposes.

In another aspect, the invention provides a process for sequestration of carbon dioxide by mineral carbonation comprising contacting activated magnesium or calcium sheet silicate hydroxide mineral particles obtained by a mineral activation process according to the invention with carbon dioxide to convert the activated silicate hydroxide mineral into magnesium or calcium carbonate and silica.

### DETAILED DESCRIPTION OF THE INVENTION

In the process according to the invention, a magnesium or calcium sheet silicate hydroxide mineral (herein below also referred to as silicate hydroxide mineral) is activated.

Silicates are composed of orthosilicate monomers, i.e. the orthosilicate ion SiO₄⁴⁻ which has a tetrahedral structure. Orthosilicate monomers form oligomers by means of O—Si—O bonds at the polygon corners. The Q^{s} notation refers to the connectivity of the silicon atoms. The value of superscript s defines the number of nearest neighbour silicon atoms to a given Si. Orthosilicates, also referred to as nesosilicates, are silicates which are composed of distinct orthosilicate tetrathedra that are not bonded to each other by means of O—Si—O bonds (Q⁰ structure). Chain silicates, also referred to as inosilicates, might be single chain (SiO₃²⁻ as unit structure, i.e. a (Q²)ₙ structure) or double chain silicates ((Q³Q²)ₙ structure). Sheet silicate hydroxides, also referred to as phyllosilicates, have a sheet structure (Q³)ₙ.

Above a certain temperature, the sheet silicate hydroxide mineral, such as magnesium or calcium sheet silicate hydroxide mineral, is converted into its corresponding ortho- or chain silicate mineral, silica and water. Serpentine for example is converted at a temperature of at least 500° C. into olivine. Talc is converted at a temperature of at least 800° C. into enstatite. This process is referred to as to as activation. The temperature at which activation commences is referred to as the activation temperature.

In the process according to the invention the activation of the silicate hydroxide mineral particles takes place at elevated temperatures, i.e. close to or above the activation temperature. During the activation of the silicate hydroxide mineral at least part the silicate hydroxide mineral is converted into an ortho- or chain silicate mineral, silica and water. In case of for instance a magnesium silicate hydroxide mineral the activation may, for example, follow formula (I):

Mg₃Si₂O₅(OH₄)→1.5Mg₂SiO₄+0.5SiO₂+2H₂O(g) (1)

Preferably, the silicate hydroxide mineral is converted into an amorphous magnesium or calcium ortho- or chain silicate mineral.

Additionally, the activation of the silicate hydroxide mineral may include a conversion of part of the silicate hydroxide mineral into an amorphous magnesium or calcium silicate hydroxide mineral derived compound.

The product of activation is an activated magnesium or calcium sheet silicate hydroxide mineral, further also referred to as activated mineral.

In the process according to the invention the energy required for the activation is supplied by reacting a fluid fuel with molecular oxygen. Such reaction between a fuel and oxygen is generally known as combustion. The combustion of the fuel may take place in the direct vicinity of a bed of silicate hydroxide mineral particles or, preferably, takes place inside a bed of silicate hydroxide mineral particles. By combusting the fuel inside the bed, the energy necessary to active the silicate hydroxide mineral is produced in-situ. There is no need to provide additional externally produced energy, for instance by feeding a hot gas, such as syngas, to the bed of silicate hydroxide mineral particles.

Preferably, the process is operated using a fluidised bed, i.e. the bed of silicate hydroxide mineral particles is a fluidised bed and silicate hydroxide mineral particles are supplied to the bed and activated mineral particles and flue gas are removed from the bed. Preferably, the fluid fuel and molecular oxygen, e.g. in the form of air, are used as fluidising agent. Fluidised beds provide efficient transfer of heat to the mineral particles and provide an optimal heat distribution throughout the fluidised bed, reducing the creation of hot spots inside the bed. Furthermore, state of the art control of fluidised beds allows for a good temperature control inside the bed. Fluidised bed furnaces with internal combustion are generally described in the open literature. An example, where such furnaces are described is: “R. W. Reynoldson, Heat Treatment in Fluidized Bed Furnaces, ASM International, 1993”.

The silicate hydroxide mineral particles may be preheated prior to entering the fluidised bed. Preferably, the silicate hydroxide mineral particles are preheated to a temperature close to the temperature at which the silicate hydroxide mineral is activated. The silicate hydroxide mineral particles may for instance be pre-heated via heat exchange with other process streams, for example the obtained activated mineral and/or flue gas. Preferably, the silicate hydroxide mineral particles are preheated to a temperature no more than 200° C., more preferably no more than 150° C., even more preferably no more than 100° C., below the temperature below that temperature at which the silicate hydroxide mineral particles are activated. Preferably, the silicate hydroxide mineral particles are preheated to a temperature not more than 20° C., more preferably not more than 5° C., above the temperature at which the silicate hydroxide mineral particles are activated. Even more preferably, the silicate hydroxide mineral particles are preheated to a temperature equal to or below the temperature at which the preheated silicate hydroxide mineral particles are activated. The advantage of preheating the silicate hydroxide mineral is that the residence time in the activation zone is reduced, resulting in a better control of the net residence time and extent of conversion. As a consequence, a narrow compositional spread may be obtained.

If the silicate hydroxide mineral is serpentine, the activation is preferably carried out in a fluidised bed having a temperature in the range of from 500 to 800° C., more preferably of from 600 to 700° C., even more preferably of from 620 to 650° C. At temperatures between 620 to 650° C. a maximum reactivity of the activated mineral toward carbon dioxide was obtained. Below 500° C., there is no significant conversion of serpentine into olivine. Above 800° C., a crystalline form of olivine is formed that is more difficult to convert into magnesium carbonate than the amorphous olivine formed at a temperature below 800° C. It will be appreciated that crystallization of olivine can already occur to some extent at temperatures lower than 800° C., however, it should be realised that this requires prolonged residence times at such temperatures.

If the silicate hydroxide is talc, the fluidised bed preferably has a temperature in the range of from 800 to 1000° C.

It will be appreciated that the ratio of silicate hydroxide mineral particles supplied to the fluidised bed and the flow velocity of the fuel and molecular oxygen-comprising gas should be such that sufficient energy can be provided to further heat the silicate hydroxide mineral particles supplied to the fluidised bed to or above the activation temperature and to obtain the desired degree of activation within the residence time of the mineral particle inside the fluidised bed. The suggested control of such a fluidised bed may depend on several conditions including the size of the silicate hydroxide mineral particles supplied to the fluidised bed, flow and choice of fuel and molecular oxygen-comprising gas supplied to the bed of mineral particles, and temperature of the bed. It should be noted that the suggested control of such a fluidised bed falls within the practical knowledge of a person skilled in the art of fluidised beds.

As mentioned hereinabove, the residence time of the silicate hydroxide mineral particles under activation conditions is of influence on the activation and resulting composition of the obtained activated mineral. Preferably, the silicate hydroxide particles have a residence time in the fluidised bed in the range of from 1 second to 180 minutes. It will be appreciated that the optimal residence time is dependent on the temperature of the fluidised bed. In case of a fluidised bed temperature of in the range of from 620 to 650° C., the residence time is preferably in the range of from 50 to 70 minutes, more preferably of from 55 to 65 minutes, for example 60 minutes. These residence times provide that a sufficient degree of activation is achieved, while minimising the formation of less desired mineral products.

The silicate hydroxide mineral particles supplied to the fluidised bed preferably have an average diameter in the range of from 10 to 500 μm, more preferably of from 150 to 300 μm, even more preferably of from 150 to 200 μm. Reference herein to average diameter is to the volume medium diameter D(v, 0.5), meaning that 50 volume % of the particles have an equivalent spherical diameter that is smaller than the average diameter and 50 volume % of the particles have an equivalent spherical diameter that is greater than the average diameter. The equivalent spherical diameter is the diameter calculated from volume determinations, e.g. by laser diffraction measurements.

In the process according to the invention, silicate hydroxide mineral particles of the desired size may be supplied to the, fluidised, bed. Alternatively, larger particles, i.e. up to a few mm, may be supplied. As a result of the expansion of the steam formed during the conversion reaction in step (a), the larger particles may fragment into the desired smaller particles.

It will be appreciated that the process conditions such as temperature, residence time and particle size may also be applied when using a fixed bed of silicate hydroxide mineral particles.

Reference herein to magnesium or calcium sheet silicate hydroxide is to silicate hydroxides comprising magnesium, calcium or both. Silicate hydroxides comprising magnesium are preferred due to their abundances in nature. Part of the magnesium or calcium may be replaced by other metals, for example iron, aluminium or manganese. Any magnesium or calcium silicate hydroxide belonging to the group of sheet silicates may be suitably used in the process according to the invention. Examples of suitable silicate hydroxides are serpentine, talc and sepiolite. Serpentine and talc are preferred silicate hydroxides. Serpentine is particularly preferred.

Serpentine is a general name applied to several members of a polymorphic group of minerals having comparable molecular formulae, i.e. (Mg,Fe)₃Si₂O₅(OH)₄ or Mg₃Si₂O₅(OH)₄, but different morphologic structures. In the process according to the invention, serpentine may be converted into olivine or into an amorphous serpentine-derived compound. The olivine may be amorphous or crystalline. Preferably, the olivine is amorphous. The olivine obtained is a magnesium silicate having the molecular formula Mg₂SiO₄ or (Mg,Fe)₂SiO₄, depending on the iron content of the reactant serpentine. Serpentine with a high magnesium content, i.e. serpentine that has no Fe or deviates little from the composition Mg₃Si₂O₅(OH)₄, is preferred since the resulting olivine has the composition Mg₂SiO₄ and can sequester more carbon dioxide than olivine with a substantial amount of magnesium replaced by iron.

Talc is a mineral with chemical formula Mg₃Si₄O₁₀(OH)₂. In process according to the invention, talc may be converted into enstatite, i.e. MgSiO₃, or into amorphous talc.

The fuel supplied in step (b) may be any fuel that can exothermally react, i.e. be combusted, with oxygen. Such fuels include solid fuels such as coal or biomass. Preferably, the fuel is a fluid fuel, more preferably a gaseous fuel. Suitable fuels include hydrocarbonaceous fuels, hydrogen, carbon monoxide or a mixture of one or more thereof. Examples of suitable fuels include natural gas, associated gas, methane, heavy Paraffin Synthesis (HPS)-off gas and syngas. These fuels are clean, for instance compared to fuels like coal, and are typically available at carbon dioxide production sites. Syngas generally refers to a gaseous mixture comprising carbon monoxide and hydrogen, optionally also comprising carbon dioxide and steam. Syngas is usually obtained by partial oxidation or gasification of a hydrocarbonaceous feedstock. Examples of processes producing syngas include coal, gas or biomass-to-liquid.

The molecular oxygen-comprising gas may for instance be air, oxygen enriched air or substantially pure oxygen. When oxygen enriched air or substantially pure oxygen are used the flue gas is less or essentially not diluted with nitrogen. This may be beneficial if the flue gas is to be further treated, for instance by removing carbon dioxide.

If the fuel comprises carbon atoms, fuel and molecular oxygen are supplied such that the oxygen-to-carbon molar ratio is preferably 0.85 or higher, more preferably 0.95 or higher. Even more preferred is that the oxygen-to-carbon molar ratio is in the range of from 0.95 to 1.5. Reference herein to the oxygen-to-carbon molar ratio is to the number of moles of molecular oxygen (O₂) to the number of moles of carbon atoms in the fuel. In such ratios the fuel combusts cleanly and therefore produces a flue gas, which comprises less ashes or other solids. Such ashes and other solids may contaminate the obtained activated mineral.

The fluid fuel and molecular oxygen-comprising gas may be supplied to the bed of silicate hydroxide mineral particles separately or in the form of a mixture comprising the fluid fuel, molecular oxygen and optionally another fluid. If the fluid fuel and molecular oxygen-comprising gas are supplied separately it may be necessary to provide a means for ensuring that both fuel and molecular oxygen are well distributed throughout the bed.

Another aspect of the invention, provides a process for the sequestration of carbon dioxide by mineral carbonation comprising contacting activated magnesium or calcium sheet silicate hydroxide mineral particles obtained by the mineral activation process according to the present invention with carbon dioxide to convert the activated mineral into magnesium or calcium carbonate and silica.

The activated mineral according to the invention is particularly suitable for mineral carbonation of carbon dioxide. Although the exact mineral structure of the obtained activated mineral is unknown, it is known that it may contain substantial amounts of amorphous minerals, such as amorphous olivine and/or amorphous serpentine-derived compounds. In contrast, naturally occurring olivine and serpentine are essentially crystalline. It has been found that the reaction rate of carbon dioxide with the activated mineral obtained by the mineral activation process according to the invention is significantly higher than the reaction rate of carbon dioxide with naturally occurring crystalline olivine.

In the mineral carbonation process, the carbon dioxide is typically contacted with an aqueous slurry of the activated mineral particles. In order to achieve a high reaction rate, it is preferred that the carbon dioxide concentration is high, which can be achieved by applying an elevated carbon dioxide pressure. Suitable carbon dioxide pressures are in the range of from 0.05 to 100 bar (absolute), preferably in the range of from 0.1 to 50 bar (absolute). The total process pressure is preferably in the range of from 1 to 150 bar (absolute), more preferably of from 1 to 75 bar (absolute).

A suitable operating temperature for the mineral carbonation process is in the range of from 20 to 250° C., preferably of from 100 to 200° C.

The carbon dioxide may for instance be initially comprised in a flue gas. Reference herein to flue gas is to an off gas of a combustion reaction, typically the combustion of a hydrocarbonaceous feedstock. The combustion of a hydrocarbonaceous feedstock gives a flue gas typically comprising a gaseous mixture comprising carbon dioxide, water and/or optionally nitrogen.

Alternatively, the carbon dioxide may be comprised in the product gas of a water-gas shift reactor, wherein the CO in for instance a syngas is reacted with water to a mixture of hydrogen and carbon dioxide.

Typically the activation of the silicate hydroxide mineral will include the conversion to a silicate mineral. A by-product of this conversion is water, which is obtained in the form of steam with the flue gas. The water obtained during the activation may be used for instance to provide an aqueous slurry in the mineral carbonation process according to the invention.

Alternatively, the water obtained during the activation may be recovered from the flue gas and be used for other applications, such as part of the feed to a steam methane reformer, water-gas shift reactor, or be used in the generation of power.

The process according to the invention is particularly suitable to sequester the carbon dioxide in flue gas obtained from boilers, gas turbines, or carbon dioxide in syngas from coal gasification or coal, gas or biomass-to-liquid units. The process according to the invention may advantageously be combined with such processes. Gas turbines are typically fed with natural gas or syngas. Coal gasification and coal, gas or biomass-to-liquid unit comprise producing syngas. Both syngas and natural gas are especially suitable fuels for use in the mineral activation process of the present invention and available at the site of a gas turbine, coal gasification or coal, gas or biomass-to-liquid unit.

In case the flue gas from the mineral activation process comprises carbon dioxide, this carbon dioxide may be sequestrated at least in part by contacting the carbon dioxide with the activated mineral in the mineral carbonation process top sequester at least part of the carbon dioxide.

### Example

The process according to the invention will be further illustrated by the following non-limiting example (1).

In a process 100 ton/h of carbon dioxide is captured and separated. 210 ton/h of serpentine is required to convert this carbon dioxide completely into magnesium carbonate. Serpentine activation is performed using a fluidised bed. The serpentine is pre-heated to 560° C. via heat exchange with flue gas of 650° C. obtained form the fluidised bed. Serpentine activation takes place at 650° C. To provide the heat for further heating of the serpentine to 650° C. and the activation 3.5 ton/h of natural gas (LHV=37.9 MJ/m³) is combusted in the fluidised bed with 63 ton/h of air to yield a bed temperature of 650° C.

Combustion of the natural gas will result in the production of 9.3 ton/h additional carbon dioxide. Therefore the net carbon dioxide removal efficiency is 91%.

1. A process for the activation of a magnesium or calcium sheet silicate hydroxide mineral comprising:
(a) providing a bed of magnesium or calcium sheet silicate hydroxide mineral particles;
(b) supplying to such bed a fluid fuel and molecular oxygen-comprising gas; and
(c) allowing the fuel and molecular oxygen to react to obtain activated magnesium or calcium sheet silicate hydroxide mineral particles and a flue gas.

2. The process according to claim 1, wherein the bed of magnesium or calcium sheet silicate hydroxide mineral particles is a fluidised bed and magnesium or calcium sheet silicate hydroxide mineral particles are supplied to the bed and activated magnesium or calcium sheet silicate hydroxide mineral particles and flue gas are removed from the bed.

3. The process according to claim 2, wherein the magnesium or calcium sheet silicate hydroxide mineral is serpentine.

4. The process according to claim 3, wherein the fluidised bed has a temperature in the range of from 500 to 800° C.

5. The process according to claim 4, wherein the magnesium or calcium sheet silicate hydroxide mineral particles have a residence time in the bed and the residence time is in the range of from 1 second to 180 minutes.

6. The process according to claim 5, wherein the magnesium or calcium sheet silicate hydroxide mineral is serpentine, the fluidised bed has a temperature in the range of from 500 to 800° C. and the residence time is in the range of from 50 to 70 minutes.

7. The process according to claim 6 wherein the fluid fuel is a hydrocarbonaceous fuel, hydrogen, carbon monoxide or a mixture of one or more thereof.

8. The process according to claim 7, wherein the fluid fuel is a hydrocarbonaceous fuel.

9. The process according to claim 7, wherein the fluid fuel is syngas.

10. The process according to claim 9, wherein the molecular oxygen-comprising gas is air, oxygen enriched air, substantially pure oxygen.

11. The process according to claim 10, wherein the magnesium or calcium sheet silicate hydroxide mineral particles have an average diameter in the range of from 10 to 500 μm.

12. The process according to claim 11, wherein the obtained activated magnesium or calcium sheet silicate hydroxide mineral particles and/or flue gas are used to preheat the silicate hydroxide.

13. An activated magnesium or calcium sheet silicate hydroxide mineral obtainable by a process comprising:
(a) providing a bed of magnesium or calcium sheet silicate hydroxide mineral particles;
(b) supplying to such bed a fluid fuel and molecular oxygen-comprising gas; and
(c) allowing the fuel and molecular oxygen to react to obtain activated magnesium or calcium sheet silicate hydroxide mineral particles and a flue gas.

14. The process of claim 1, further comprising contacting the activated magnesium or calcium sheet silicate hydroxide mineral particles with carbon dioxide to convert the activated magnesium or calcium sheet silicate hydroxide mineral into magnesium or calcium carbonate and silica.

15. A process according to claim 14, wherein a flue gas obtained by a process according to any one of claims 1 to 12 comprises carbon dioxide and at least part of the flue gas is contacted with the activated magnesium or calcium sheet silicate hydroxide mineral particles to sequester at least part of the carbon dioxide in the flue gas.
